(19) United States
(12) Patent Application Publication
(10) Pub. No.: US 2025/0309587 A1
(43) Pub. Date: Oct. 2, 2025

(54) Socket Device

(71) Applicant: Anker Innovations Technology Co., Ltd., Changsha (CN)

(72) Inventors: Xianjie Tang, Shenzhen (CN); Tao Chen, Shenzhen (CN)

(21) Appl. No.: 19/085,535

(22) Filed: Mar. 20, 2025

(30) Foreign Application Priority Data
Mar. 27, 2024 (CN) 202420612804.6

(51) Int. Cl. H01R 13/631; H01R 13/502; H01R 24/22

(52) U.S. Cl. CPC H01R 13/631; H01R 13/502; H01R 24/22

(57) ABSTRACT

A socket comprises a shell, a socket panel, and a transmission member. The shell has an accommodating chamber and an opening. The socket panel is arranged on the shell, and configured to slide relative to the shell along an axial direction of the opening. The transmission member is located in the accommodating chamber and is connected to the shell along a first direction. The transmission member comprises a first transmission portion, and the socket panel comprises a second transmission portion. The first transmission portion can be coupled to the second transmission portion. In response to an insertion of a pin into an insertion hole, the transmission member is configured to slide relative to the shell along the first direction, to drive the first transmission portion to slide relative to the second transmission portion, and drive the socket panel to slide along the axial direction of the opening.

### CROSS REFERENCE TO RELATED APPLICATION

The present application claims priority to Chinese Patent Application No. 202420612804.6, entitled “Socket” filed on Mar. 27, 2024, which is incorporated herein by reference in its entirety.

### TECHNICAL FIELD

The present application relates to the technical field of sockets.

### BACKGROUND

Sockets have become one type of essential tools in people's lives. In related technologies, because pins of a plug need to be fully inserted into a socket, the overall thickness of the socket is greater than the insertion depth of the plug, making the overall volume of the socket and the mounting space relatively large.

### SUMMARY

The present application provides a socket (e.g., a socket device), enabling a shell of a plug to be thinner, thereby reducing the mounting space for the socket.

For example, the present application provides a socket, comprising a shell, a socket panel, and a transmission member. The shell has an accommodating chamber and an opening, and the opening is in communication with the accommodating chamber. The socket panel is arranged on the shell, and the socket panel is configured to slide relative to the shell along an axial direction of the opening to enter or exit the accommodating chamber through the opening. The socket panel is provided with an insertion hole, and the insertion hole is configured for inserting a pin of a plug. The transmission member is located in the accommodating chamber, and the transmission member is connected to the shell along a first direction and connected to the socket panel. The first direction is perpendicular to the axial direction of the opening.

The transmission member comprises a first transmission portion. The socket panel comprises a second transmission portion, and the first transmission portion cooperates with (e.g., is coupled to) the second transmission portion. In response to insertion of the pin is inserted into the insertion hole, the pin abuts against the transmission member and drives the transmission member to slide relative to the shell along the first direction, so that the first transmission portion slides relative to the second transmission portion to drive the socket panel to slide along the axial direction of the opening to extend out of the accommodating chamber.

The beneficial effects of the present application are as follows: By arranging the transmission member and the socket panel capable of lifting or lowering in the shell, the transmission member can slide under the action of the pin, the sliding of the transmission member enables the first transmission portion to slide relative to the second transmission portion, and the sliding of the first transmission portion can drive the socket panel to slide in and out of the accommodating chamber along the axial direction of the opening. In this way, when the plug is not inserted into the socket, the socket panel is stored in the accommodating chamber of the shell, making the shell of the socket thinner and saving storage and mounting space for the socket. When the plug is inserted into the socket, the socket panel extends out of the accommodating chamber for fully inserting the pin into the socket, so that the plug can be powered.

### BRIEF DESCRIPTION OF THE DRAWINGS

To describe the technical solutions in the present application more clearly, the following briefly introduces the accompanying drawings required for describing the present application. Apparently, the accompanying drawings in the following description show only some examples of the present application, and those of ordinary skill in the art can derive other drawings from the accompanying drawings without any creative efforts.

FIG. 1 is a schematic structural diagram of a socket and a plug in an example of the present application;

FIG. 2 is an exploded structural diagram of the plug in an example of the present application;

FIG. 3 is a schematic structural diagram of a transmission member located at a first position in an example of the present application;

FIG. 4 is a schematic structural diagram of the transmission member located at a second position in an example of the present application;

FIG. 5 is a schematic structural diagram of the transmission member and a portion of a shell in an example of the present application;

FIG. 6 is a cross-sectional structural diagram of the socket and the plug in an example of the present application;

FIG. 7 is a schematic structural diagram of the transmission member, a socket panel, and a portion of the shell in an example of the present application;

FIG. 8 is a schematic diagram of a first cross-sectional structure when the plug is not inserted into the socket in an example of the present application;

FIG. 9 is a schematic diagram of a first cross-sectional structure when the plug is inserted into the socket in an example of the present application;

FIG. 10 is a schematic diagram of a second cross-sectional structure when the plug is not inserted into the socket in an example of the present application; and

FIG. 11 is a schematic diagram of a second cross-sectional structure when the plug is inserted into the socket in an example of the present application.

### REFERENCE NUMERALS

1. Socket; 10. Shell; 11. Accommodating chamber; 12. Opening; 13. Bottom plate; 14. Fixed bracket; 15. Cover plate; 16. Protrusion; 17. Limit column; 20. Socket panel; 21. Insertion hole; 211. First insertion hole; 22. Second transmission portion; 221. Transmission pin; 23. Limit grove; 24. First side; 30. Transmission member; 31. First inclined surface; 32. Through hole; 33. Blocking portion; 34. First transmission portion; 341. Chute; 3411. First end; 3412. Second end; 35. Sliding groove; 41. Conductive member; 411. Clamping groove; 42. First elastic member; 43. Second elastic member; 2. Plug; 201. Pin; L1. First direction; L2. Axial direction of the opening.

### DETAILED DESCRIPTION

In order to explain the technical solutions in the present application or in related technologies more clearly, a clear and complete description will be provided below in conjunction with the accompanying drawings in the present application. Apparently, the described examples are merely some, but not all of the examples of the present application. All other examples obtained by those of ordinary skill in the art based on the present application without creative efforts fall within the scope of protection of the present application.

In related technologies, because pins of a plug need to be fully inserted into a socket, the overall thickness of the socket is greater than the insertion depth of the plug, making the overall socket relatively large and inconvenient to carry. In addition, the socket occupies a large mounting position when mounted, so mounting space cannot be saved.

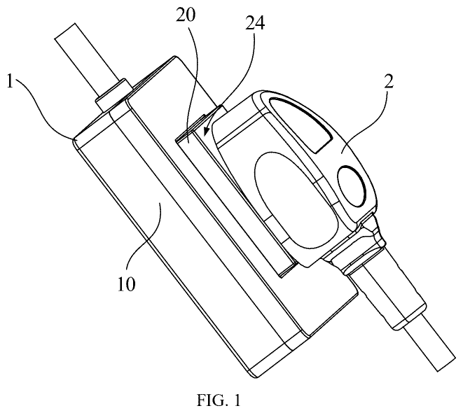

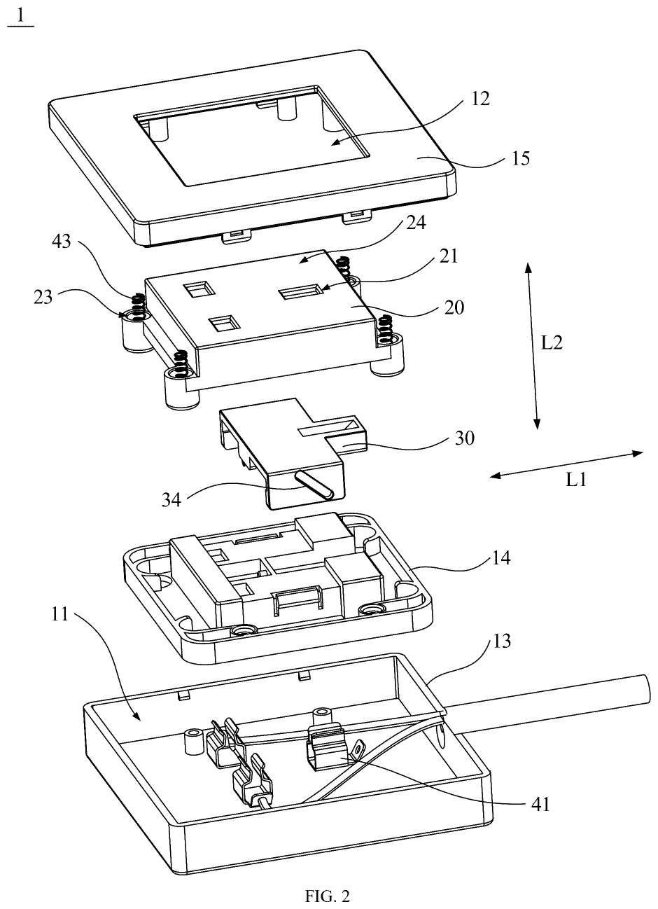

In view of the above situation, with reference to FIGS. 1 and 2, the present application provides a socket 1, including a shell 10, a socket panel 20, and a transmission member 30.

The shell 10 has an accommodating chamber 11 and an opening 12, and the opening is in communication with the accommodating chamber 11. The socket panel 20 is arranged on the shell 10, the socket panel 20 is capable of moving (e.g., sliding) relative to the shell 10 along an axial direction L2 of the opening 12 to enter or exit the accommodating chamber 11 through the opening 12, the socket panel 20 is provided with one or more holes, which includes an insertion hole 21, and the insertion hole is used for inserting a pin 201 of a plug 2. The transmission member 30 is located in the accommodating chamber 11, and the transmission member 30 can be connected to the shell 10 along a first direction LI (e.g., in a sliding manner) and in transmission connection to the socket panel 20. The first direction L1 is perpendicular to the axial direction L2 of the opening 12.

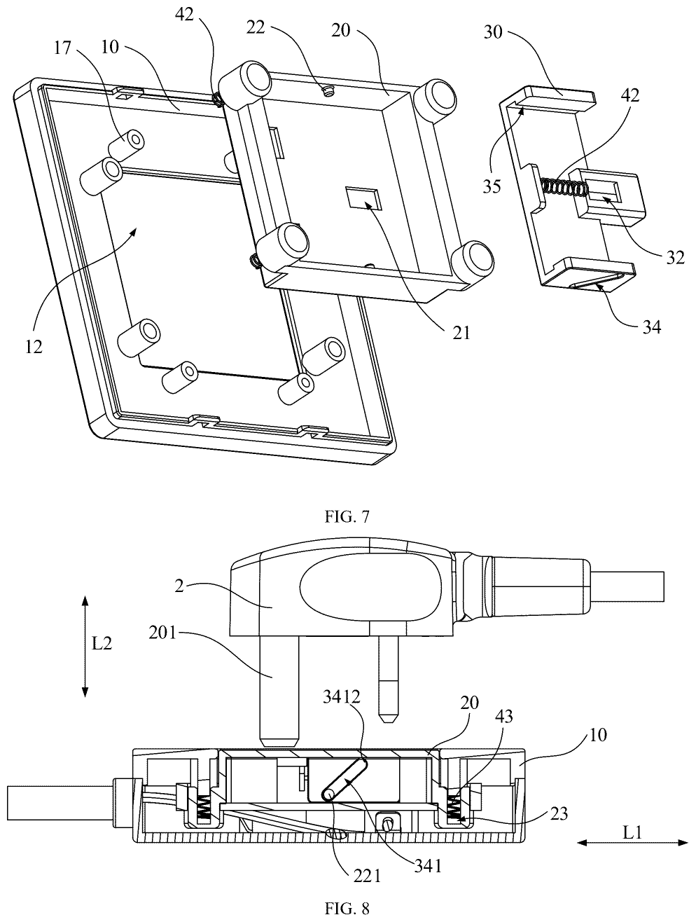

Specifically, the transmission member 30 is provided with a first transmission portion 34. The socket panel 20 is provided with a second transmission portion 22 (as shown in FIG. 7), and the first transmission portion 34 can cooperate with (e.g., be coupled to) the second transmission portion 22. When the pin 201 is inserted into the insertion hole 21, the pin 201 can abut against the transmission member 30 in the accommodating chamber 11, so that the pin 201 drives the transmission member 30 to slide relative to the shell 10 along the first direction L1, and the first transmission portion 34 located on the transmission member 30 can slide relative to the second transmission portion 22. As such, the first transmission portion 34 drives the socket panel 20 to slide along the axial direction L2 of the opening 12 to extend out of the accommodating chamber 11, and the pin 201 of the plug 2 can be fully inserted into the socket 1.

Specific structures of and their cooperation relationship between the first transmission portion 34 and the second transmission portion 22 will be described in detail below. The insertion hole 21 may be a British standard insertion hole 21, a Chinese standard insertion hole 21, or an American standard insertion hole 21. In an example, when the plug 2 is not inserted into the socket 1, the socket panel 20 is stored in the accommodating chamber 11 to reduce the space occupied by the socket 1.

It should be noted that, in the examples of the present application, the socket panel 20 and the transmission member 30 are arranged in the shell 10, the transmission member 30 can slide under the action of the pin 201, and the first transmission portion 34 also slides relative to the second transmission portion 22, so that the first transmission portion 34 on the transmission member 30 can drive the socket panel 20 to slide in and out of the accommodating chamber 11 along the axial direction L2 of the opening 12. Therefore, when the plug 2 is not inserted into the socket 1, the socket panel 20 is stored in the accommodating chamber 11 of the shell 10, making the shell 10 of the socket 1 thinner and saving storage and mounting space for the socket 1. When the plug 2 is inserted into the socket 1, the socket panel 20 extends out of the accommodating chamber 11 for fully inserting the pin 201 into the socket 1, so that the plug 2 can be stably powered.

In some examples, the shell 10 includes a bottom plate 13, a fixed bracket 14, and a cover plate 15. The cover plate 15 is located above the bottom plate 13. The cover plate 15 is clamped with the bottom plate 13 to form the accommodating chamber 11. The opening 12 is located on the cover plate 15. The fixed bracket 14 is located in the accommodating chamber 11, and the fixed bracket 14 is fixed to the bottom plate 13 by screwing. The socket panel 20 is movably connected to the cover plate 15 along the axial direction L2 of the opening 12. The transmission member 30 is connected to the fixed bracket 14 (e.g., in a sliding manner), and the transmission member 30 is in transmission connection to the socket panel 20. A first baffle and a second baffle arranged at interval are further provided on the fixed bracket 14, the transmission member 30 is arranged between the first baffle and the second baffle, the transmission member 30 can slide between the first baffle and the second baffle, and the first baffle and the second baffle confine a movable distance for the transmission member 30 to prevent the transmission member 30 from sliding too far.

With reference to FIGS. 3-5, in some examples of the present application, the first transmission portion 34 includes a guide groove such as a chute 341, the chute is formed on a side of the transmission member 30, and the chute 341 is inclined away from the opening 12. The second transmission portion 22 includes a transmission pin 221, and the transmission pin is used for being inserted into the chute 341 (as shown in FIGS. 7-9). When the pin 201 is inserted into the insertion hole 21, the pin 201 drives the transmission member 30 to slide along the first direction L1, so that the transmission pin 221 slides along the chute 341, and the socket panel 20 is driven to slide along the axial direction L2 of the opening 12 to extend out of the accommodating chamber 11.

Specifically, the transmission member 30 is located between the shell 10 and the socket panel 20. The chute 341 is located on the side of the transmission member 30 and inclined away from the opening 12, and the transmission pin 221 extends along a second direction. The second direction is perpendicular to both the first direction L1 and the axial direction L2 of the opening 12. The chute 341 has a first end 3411 and a second end 3412 opposite to each other. The first end 3411 is located at a position of the transmission member 30 away from the socket panel 20, and the second end 3412 is located at a position of the transmission member 30 close to the socket panel 20. The transmission pin 221 can slide in the chute 341. When the transmission member 30 is located at a first position, the transmission pin 221 is located at the first end 3411 of the chute 341, and the socket panel 20 is stored in the accommodating chamber 11. When the pin 201 is inserted into the insertion hole 21, the transmission member 30 slides from the first position to a second position, the transmission pin 221 slides from the first end 3411 to the second end 3412 of the chute 341, and the socket panel 20 slides along the axial direction L2 of the opening 12 to extend out of the accommodating chamber 11.

In an example, the transmission member 30 includes an inclined plate, the inclined plate is inclined away from the opening 12, the inclined plate abuts against the socket panel 20, and the inclined plate has a lowest end away from the socket panel 20 and a highest end close to the socket panel 20. When the transmission member 30 is located at the first position, the socket panel 20 is located at the lowest end of the inclined plate. When the transmission member 30 slides from the first position to the second position, the socket panel 20 slides from the lowest end to the highest end of the inclined plate, so that the socket panel 20 slides along the axial direction L2 of the opening 12 to extend out of the accommodating chamber 11.

With continued reference to FIGS. 1 and 2, in some examples of the present application, the socket panel 20 has a first side 24, and the insertion hole 21 is formed on the first side 24. When the pin 201 is not inserted into the insertion hole 21, the first side 24 is flush with an outer side of the shell 10 for easy storage and placement. When the pin 201 is inserted into the insertion hole 21, the socket panel 20 extends out of the accommodating chamber 11 along the axial direction L2 of the opening 12, and the first side 24 contacts an insertion surface of the plug 2 to improve the stability of the plug 2 after being inserted into the socket 1.

With reference to FIG. 3, in some examples of the present application, the transmission member 30 is provided with a first inclined surface 31, the first inclined surface 31 is inclined away from the opening 12, and a movable trajectory of the transmission member 30 has the first position. When the transmission member 30 is located at the first position, the first inclined surface 31 is opposite to the insertion hole 21.

Specifically, when the pin 201 is inserted into the insertion hole 21 on the socket panel 20, the pin 201 abuts against the first inclined surface 31 below the insertion hole 21, and an end portion of the pin 201 can slide along the first inclined surface 31. The first inclined surface 31 provides guidance for the pin 201, the pin 201 drives the transmission member 30 to slide along the first direction L1, and the first transmission portion 34 located on the transmission member 30 can slide relative to the second transmission portion 22, so that the sliding of the first transmission portion 34 can drive the second transmission portion 22 and the socket panel 20 to slide along the axial direction L2 of the opening 12 to extend out of the accommodating chamber 11. For example, the axial direction L2 of the opening 12 extends vertically, and the first direction L1 is horizontal. The pin 201 is inserted into the insertion hole 21 vertically, and the pin 201 contacts the first inclined surface 31 and produces a force on the first inclined surface 31. As such, the pin 201 slides relative to the first inclined surface 31, and the transmission member 30 is pushed to slide horizontally, so that the pin 201 can be inserted into the interior of the socket 1.

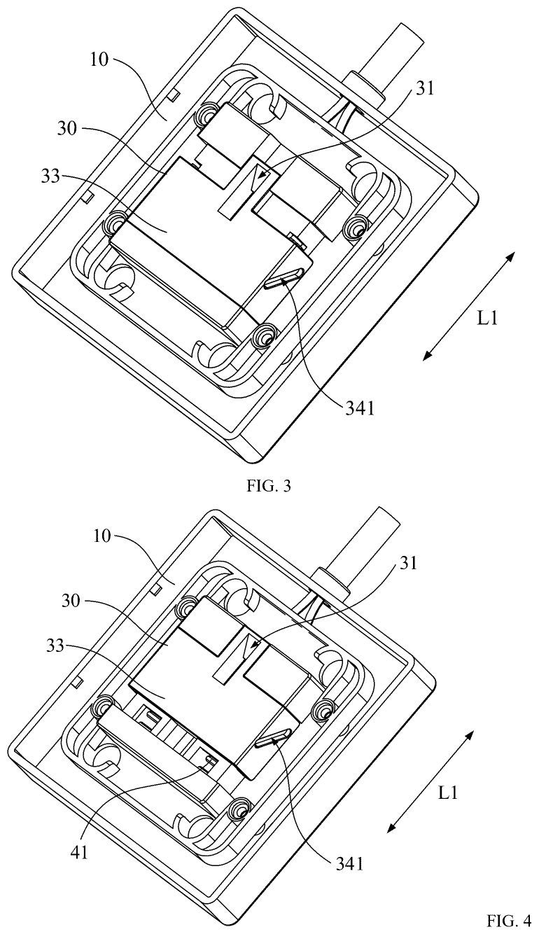

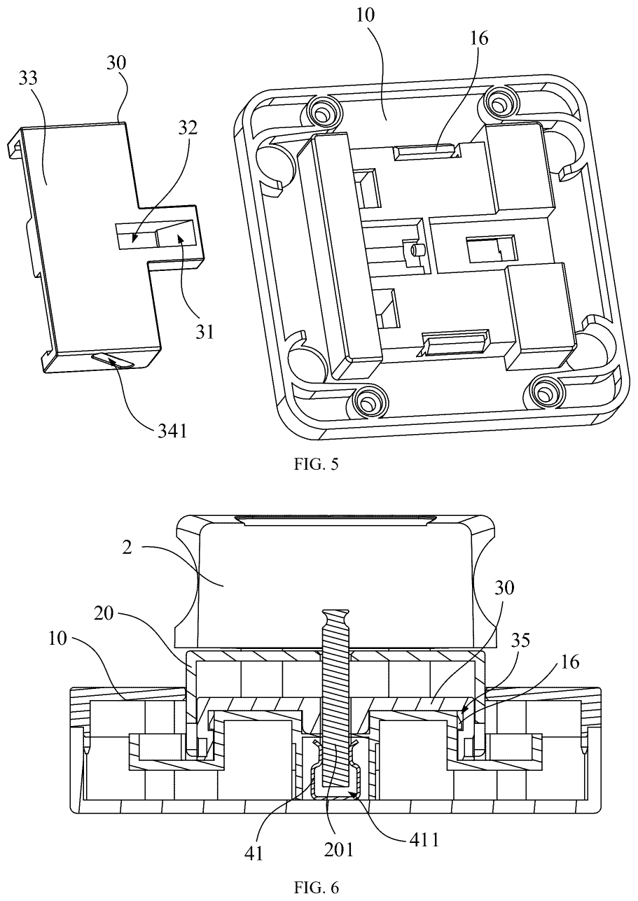

Further, with reference to FIGS. 4-6, in some examples of the present application, the socket 1 further includes a conductive member 41 (e.g., metal clip, metal plate), the conductive member is arranged in the accommodating chamber 11, and the conductive member 41 may correspond to (e.g., opposite to) the insertion hole 21. The transmission member 30 is provided with a through hole 32, and the through hole 32 and the first inclined surface 31 are arranged along the first direction L1. The movable trajectory of the transmission member 30 further has the second position. When the pin 201 is inserted into the insertion hole 21, the transmission member 30 is driven to slide from the first position to the second position, the pin 201 passes through the through hole 32 and contacts the conductive member 41, and the socket panel 20 extends out of the accommodating chamber 11.

When the plug 2 is not inserted into the socket 1 (e.g., when the pin 201 is not inserted into the insertion hole 21), the transmission member 30 is located at the first position. After the pin 201 is inserted into the insertion hole 21, the end portion of the pin 201 abuts against the first inclined surface 31 and drives the transmission member 30 to slide along the first direction L1, then the pin 201 slides along the first inclined surface 31 until the pin 201 passes through the through hole 32, is inserted into the interior of the accommodating chamber 11 and contacts the conductive member 41, and the transmission member 30 is located at the second position.

In some examples, a wire is further provided in the accommodating chamber 11 of the socket 1, a power connection hole is formed on the shell 10, one end of the wire is electrically connected to an external power source, and the other end of the wire extends into the accommodating chamber 11 via the power connection hole and is electrically connected to the conductive member 41, so as to transmit external power to the conductive member 41 and the pin 201 of the plug 2. The conductive member 41 has a clamping groove 411. When the pin 201 is inserted into the insertion hole 21, the end portion of the pin 201 enters the clamping groove 411 and is clamped with the clamping groove 411, thereby ensuring stable contact between the pin 201 and the conductive member 41 and reducing shaking of the pin 201.

With reference to FIGS. 3-5, in some examples of the present application, a plurality of insertion holes 21 are provided, the plurality of insertion holes 21 include a first insertion hole 211, and the transmission member 30 is further provided with a blocking portion 33. When the transmission member 30 is located at the first position, the first inclined surface 31 corresponds to (e.g., is opposite to) the first insertion hole 211 (e.g., the first inclined surface 31 blocks the first insertion hole 211), the blocking portion 33 corresponds to (e.g., is opposite to) other insertion holes 21 among the plurality of insertion holes 21, and the blocking portion 33 blocks all the other insertion holes 21. When the pin 201 is inserted into the insertion hole 21, one pin 201 abuts against the first inclined surface 31 and drives the transmission portion 30 to slide from the first position to the second position, the first inclined surface 31 and the blocking portion 33 are misaligned with all the insertion holes 21, and all the insertion holes 21 are exposed for inserting the pins 201 (e.g., the transmission portion 30 slides to a position that does not block any insertion hole 21).

Specifically, when the pin 201 is inserted into the insertion hole 21, the end portion of the pin 201 first abuts against the first inclined surface 31 and drives the transmission member 30 to slide along the first direction L1 (e.g., the blocking portion 33 also slides along the first direction L1), then the pin 201 slides along the first inclined surface 31 until the first inclined surface 31 removes the blocking for the first insertion hole 211, the blocking portion 33 also removes the blocking for all the other insertion holes 21, one pin 201 passes through the first insertion hole 211 and the through hole 32 and is inserted into the interior of the accommodating chamber 11, and the plurality of pins 201 are in contact with the conductive member 41.

It should be noted that the conductive member 41 is provided inside the socket 1, and the conductive member 41 can be electrically connected to the external plug 2 through the insertion hole 21. The transmission member 30 can act as a safety door, and the transmission member 30 can block the plurality of insertion holes 21 when the socket 1 is not used, thereby improving electrical safety. For example, the plurality of insertion holes 21 further include a second insertion hole and a third insertion hole, the first inclined surface 31 of the transmission member 30 is used for blocking the first insertion hole 211, and the blocking portion 33 of the transmission member 30 blocks the second insertion hole and the third insertion hole. Therefore, when the socket 1 is not used, the internal conductive member 41 is not exposed at the three insertion holes 21, thereby reducing the occurrence of electric shock accidents and improving the safety protection of the socket 1.

Further, for example, the first insertion hole 211 is a ground wire insertion hole, one of the second insertion hole and the third insertion hole is a live wire insertion hole, and the other is a neutral line insertion hole. Even if a child inserts a conductor into the live wire insertion hole and/or the neutral line insertion hole on the socket 1, because the blocking portion 33 of the transmission member 30 is opposite to the live wire insertion hole and the neutral line insertion hole, the conductor inserted from any of the insertion holes cannot push the transmission member 30 through the blocking portion 33, and circuit conduction will not occur, thereby effectively reducing the occurrence of electric shock accidents.

In some examples, as shown in FIGS. 5-7, one of the transmission member 30 and the shell 10 is provided with a sliding groove 35 extending along the first direction L1, the other of the transmission member 30 and the shell 10 is provided with a protrusion 16, the protrusion 16 is located in the sliding groove 35, and the protrusion 16 can slide relative to the sliding groove 35 along the first direction L1.

For example, the transmission member 30 is provided with the sliding groove 35 extending along the first direction L1, and the shell 10 is provided with the protrusion 16 extending along the first direction L1. The transmission member 30 slides along the first direction L1 on the shell 10 (e.g., the sliding groove 35 slides along the extension direction of the protrusion 16, and the protrusion 16 cooperates with the sliding groove 35 to support, guide and limit the transmission member 30), so that the transmission member 30 remains stable during operation.

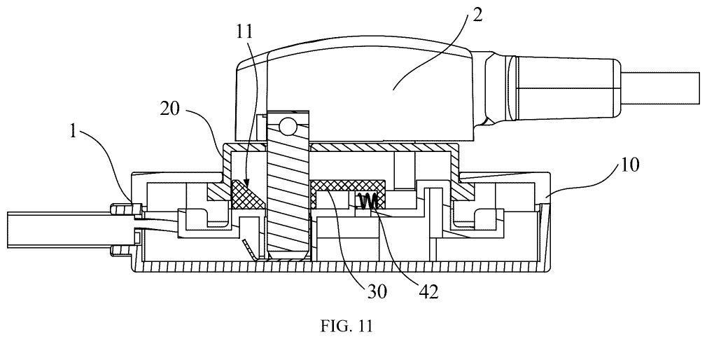

With reference to FIGS. 10 and 11, in some examples of the present application, the socket 1 further includes a first elastic member 42 (e.g., a spring), one end of the first elastic member 42 is connected to the transmission member 30, the other end of the first elastic member 42 is connected to the shell 10, the first elastic member 42 extends along the first direction L1, and the first elastic member 42 is used for resetting the transmission member 30.

Specifically, when the pin 201 is inserted into the insertion hole 21, the pin 201 drives the transmission member 30 to slide along the first direction L1, and then the transmission member 30 compresses the first elastic member 42 along the first direction L1. After the pin 201 leaves the insertion hole 21, the transmission member 30 is subjected to an elastic force of the first elastic member 42 and resets under the force, so that the first inclined surface 31 returns to the position opposite to the insertion hole 21.

In some examples of the present application, a guide rod extending along the first direction L1 is provided on the fixed bracket 14, the first elastic member 42 is sleeved on the guide rod, and the length of the guide rod along the first direction L1 is shorter than that of the first elastic member 42 along the first direction L1. It is easy to understand that when the pin 201 drives the transmission member 30 to slide along the first direction L1, the first elastic member 42 is compressed along the first direction L1 until an end portion of the guide rod contacts the transmission member 30, and then the pin 201 is fully inserted into the socket 1. The guide rod can not only guide the first elastic member 42, but also limit the sliding distance of the transmission member 30 along the first direction L1. For example, the first elastic member 42 is a spring, and the spring is sleeved on the guide rod, so that the spring can move along an axial direction of the guide rod during extension and retraction, thereby preventing position offset of the spring in other directions.

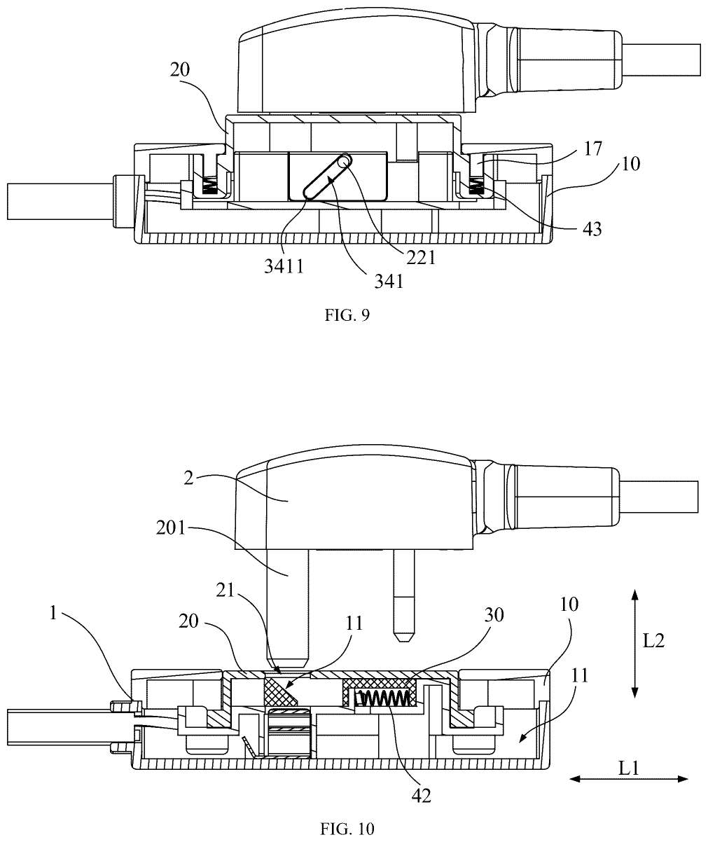

With reference to FIGS. 8 and 9, in some examples of the present application, the socket 1 further includes a second elastic member 43 (e.g., a spring), one end of the second elastic member 43 is connected to the shell 10, the other end of the second elastic member 43 is connected to the socket panel 20, the second elastic member 43 extends along the axial direction L2 of the opening 12, and the second elastic member 43 is used for resetting the socket panel 20.

Specifically, when the pin 201 is inserted into the insertion hole 21, the pin 201 drives the transmission member 30 to slide along the first direction L1, so that the transmission member 30 drives the socket panel 20 to slide along the axial direction L2 of the opening 12 to extend out of the accommodating chamber 11, and the socket panel 20 compresses the second elastic member 43 along the axial direction L2 of the opening 12. After the pin 201 leaves the insertion hole 21, the socket panel 20 is subjected to an elastic force of the second elastic member 43 and resets under the force, and the transmission member 30 is driven to return to its original position, so that the first inclined surface 31 returns to the position opposite to the insertion hole 21.

Further, with reference to FIGS. 7-9, in some examples of the present application, the socket panel 20 is provided with a limit groove 23 extending along the axial direction L2 of the opening 12, the shell 10 is provided with a limit column 17, and the limit column 17 is used for entering or exiting the limit groove 23 along the axial direction L2 of the opening 12; the second elastic member 43 is located in the limit groove 23 (as shown in FIG. 2), one end of the second elastic member 43 is connected to an end portion of the limit column 17, and the other end of the second elastic member 43 is connected to a bottom wall of the limit groove 23.

Specifically, when the socket panel 20 extends out of the accommodating chamber 11, the bottom wall of the limit groove 23 of the socket panel 20 moves towards the limit column 17 (e.g., the depth of the limit column 17 entering the limit groove 23 gradually increases), the limit column 17 and the bottom wall of the limit groove 23 compress the second elastic member 43 along the axial direction L2 of the opening 12 until the socket panel 20 slides to extend out of the accommodating chamber 11, and the pin 201 is fully inserted into the interior of the socket 1. The second elastic member 43 is located in the limit groove 23, and a peripheral wall of the limit groove 23 guides and limits the second elastic member 43 to prevent position offset of the second elastic member 43 in other directions.

The same or similar reference numerals in the accompanying drawings of the examples correspond to the same or similar components. In the description of the present application, it should be understood that, if the terms such as “up”, “down”, “left”, and “right” indicate orientations or positional relationships based on the orientations or positional relationships shown in the accompanying drawings, the terms are only for the convenience of describing the present application and simplifying the description, and do not indicate or imply that an component or element referred to must have a specific orientation or be constructed and operated in a specific orientation. Therefore, the terms for describing the positional relationships in the accompanying drawings are only for illustrative description and cannot be understood as limitations of the present application. Those of ordinary skill in the art can understand the specific meanings of the above terms according to specific situations.

Described above are merely some examples of the present application, which are not used for limiting the present application. Any modification, equivalent replacement and improvement, and the like made within the spirit and principle of the present application shall fall within the protection scope of the present application.

What is claimed is:

1. A socket, comprising:
a shell having an accommodating chamber and an opening;
a socket panel arranged on the shell, wherein the socket panel is configured to slide relative to the shell along an axial direction of the opening to enter or exit the accommodating chamber through the opening, and wherein the socket panel comprises an insertion hole; and
a transmission member located in the accommodating chamber, wherein:
the transmission member is connected to the shell along a first direction and the socket panel, the first direction being perpendicular to the axial direction of the opening,
the transmission member comprises a guide groove,
the socket panel comprises a transmission pin configured to be coupled to the guide groove, and
the transmission member is configured to slide relative to the shell along the first direction to drive the guide groove to slide relative to the transmission pin, and drive the socket panel to slide along the axial direction of the opening.

2. The socket according to claim 1, wherein:
the transmission member comprises a first inclined surface,
the first inclined surface is inclined away from the opening,
when the transmission member is located at a first position, the first inclined surface corresponds to the insertion hole, and
in response to insertion of a pin of a plug into the insertion hole, the pin abuts against the first inclined surface and drives the transmission member to slide along the first direction.

3. The socket according to claim 2, further comprising:
a conductive member in the accommodating chamber, wherein:
the conductive member corresponds to the insertion hole,
the transmission member comprises a through hole,
the through hole and the first inclined surface are arranged along the first direction, and
in response to insertion of the pin into the insertion hole, the pin passes through the through hole and contacts the conductive member.

4. The socket according to claim 3, wherein the conductive member has a clamping groove, and in response to insertion of the pin into the insertion hole, an end portion of the pin is clamped with the clamping groove.

5. The socket according to claim 3, wherein:
the socket panel comprises a plurality of insertion holes and the plurality of insertion holes comprise the insertion hole,
the transmission member comprises a blocking portion,
when the transmission member is located at the first position, the first inclined surface corresponds to the insertion hole, the blocking portion corresponds to other insertion holes of the plurality of insertion holes, and the blocking portion blocks the other insertion holes, and
when the transmission member is at a second position, the first inclined surface and the blocking portion are misaligned with the plurality of insertion holes, and the plurality of insertion holes are exposed.

6. The socket according to claim 3, wherein:
the transmission member comprises an inclined plate, the inclined plate is inclined away from the opening, the inclined plate abuts against the socket panel, and the inclined plate has a lowest end away from the socket panel and a highest end close to the socket panel,
when the transmission member is located at the first position, the socket panel is located at the lowest end of the inclined plate, and
when the transmission member slides from the first position to a second position, the socket panel slides from the lowest end to the highest end of the inclined plate, so that the socket panel slides along the axial direction of the opening to extend out of the accommodating chamber.

7. The socket according to claim 1, wherein:
one of the transmission member and the shell comprises a sliding groove extending along the first direction,
the other of the transmission member and the shell comprises a protrusion,
the protrusion is located in the sliding groove, and
the protrusion is configured to slide relative to the sliding groove along the first direction.

8. The socket according to claim 1, wherein the guide groove is a chute, the chute is formed on a side of the transmission member, and the chute is inclined away from the opening, and
wherein in response to insertion of the pin into the insertion hole, the transmission member slides along the first direction, so that the transmission pin slides along the chute, to drive the socket panel to slide along the axial direction of the opening.

9. The socket according to claim 1, further comprising:
a first spring connected to the transmission member and the shell, wherein the first spring is configured to extend along the first direction.

10. The socket according to claim 9, further comprising a fixed bracket, wherein:
the fixed bracket comprises a guide rod extending along the first direction,
the first spring is sleeved on the guide rod and along the first direction, and
a length of the guide rod is shorter than that of the first spring.

11. The socket according to claim 1, further comprising:
a second spring connected to the shell and the socket panel, wherein the second spring is configured to extend along the axial direction of the opening.

12. The socket according to claim 11, wherein:
the socket panel comprises a limit groove extending along the axial direction of the opening,
the shell is provided with a limit column,
the limit column is configured to enter and exit the limit groove along the axial direction of the opening,
the second spring is located in the limit groove, and
a first end of the second spring is connected to an end portion of the limit column, and a second end of the second spring is connected to a bottom wall of the limit groove.

13. The socket according to claim 1, wherein:
the shell comprises a bottom plate, a fixed bracket, and a cover plate,
the cover plate is located above the bottom plate and clamped with the bottom plate to form the accommodating chamber,
the opening is located on the cover plate,
the fixed bracket is located in the accommodating chamber and connected to the bottom plate and the transmission member, and
the socket panel is configured to slide relative to the cover plate along the axial direction of the opening.

14. The socket according to claim 13, wherein:
the fixed bracket comprises a first baffle and a second baffle, and
the transmission member is configured to slide between the first baffle and the second baffle.

15. The socket according to claim 1, wherein:
the socket panel has a first side, and the insertion hole is formed on the first side,
when the pin is not inserted into the insertion hole, the first side is flush with an outer side of the shell, and
in response to insertion of the pin into the insertion hole, the socket panel extends beyond the accommodating chamber along the axial direction of the opening.

16. A socket, comprising:
a shell having an accommodating chamber and an opening;
a socket panel arranged on the shell; and
a transmission member connected to the shell along a first direction and the socket panel, the first direction being perpendicular to an axial direction of the opening, wherein:
the transmission member comprises a guide groove,
the socket panel comprises a transmission pin configured to be coupled to the guide groove, and
the transmission member is configured to slide relative to the shell along the first direction to drive the guide groove to slide relative to the transmission pin, and drive the socket panel to at least partially extend beyond the accommodating chamber through the opening.

17. The socket according to claim 16, wherein:
the transmission member comprises a first inclined surface,
the first inclined surface is inclined away from the opening,
when the transmission member is located at a first position, the first inclined surface corresponds to an insertion hole of the socket panel, and
in response to insertion of a pin of a plug into the insertion hole, the pin abuts against the first inclined surface and drives the transmission member to slide along the first direction.

18. The socket according to claim 16, further comprising:
a first spring connected to the transmission member and the shell, wherein the first spring is configured to extend along the first direction, and
a second spring connected to the shell and the socket panel, wherein the second spring is configured to extend along the axial direction of the opening.

19. The socket according to claim 16, wherein:
one of the transmission member and the shell comprises a sliding groove extending along the first direction,
the other of the transmission member and the shell comprises a protrusion,
the protrusion is located in the sliding groove, and
the protrusion is configured to slide relative to the sliding groove along the first direction.

20. A system comprising:
a plug comprising a plurality of pins; and
a socket, comprising:
a shell having an accommodating chamber and an opening;
a socket panel arranged on the shell, wherein the socket panel is configured to slide relative to the shell along an axial direction of the opening to enter or exit the accommodating chamber through the opening, and wherein the socket panel comprises an insertion hole; and
a transmission member located in the accommodating chamber, wherein:
the transmission member is connected to the shell along a first direction and the socket panel, the first direction being perpendicular to the axial direction of the opening,
the transmission member comprises a guide groove,
the socket panel comprises a transmission pin configured to be coupled to the guide groove, and
in response to insertion of at least one of the plurality of pins, the transmission member slides relative to the shell along the first direction to drive the guide groove to slide relative to the transmission pin, and drive the socket panel to slide along the axial direction of the opening.
